(19) United States
(12) Patent Application Publication
(10) Pub. No.: US 2009/0121196 A1
(43) Pub. Date: May 14, 2009

(54) USE OF CARBON NANOTUBES FOR THE PRODUCTION OF A CONDUCTIVE ORGANIC COMPOSITION AND APPLICATIONS OF ONE SUCH COMPOSITION

(75) Inventor: Nour Eddine El Bounia, Orthez (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, COLOMBES CEDEX, FRANCE (FR)

(21) Appl. No.: 11/813,102

(22) PCT Filed: Jan. 5, 2006
(86) PCT No.: PCT/FR06/00016

§ 371 Date: May 2, 2008

(30) Foreign Application Priority Data
Jan. 5, 2005 (FR) 05-00-075

(51) Int. Cl. H01B 1/12

(52) U.S. Cl. 252/511; 977/752

(57) ABSTRACT

The invention relates to the use of carbon nanotubes for the production of an electrically-conductive organic composition having an electrical resistivity that is constant as a function of temperature and to the applications of said compositions. The conductive organic composition has a temperature-insensitive electrical resistivity and a temperature-insensitive thermal conductivity. Constant resistivity as a function of temperature is represented in FIG. 2.

### FIELD OF THE INVENTION

The present invention relates to the use of carbon nanotubes for the production of an electrically conductive organic composition having an electrical resistivity which is constant as a function of temperature as well as the applications of these compositions.

### PRIOR ART AND TECHNICAL PROBLEM

Carbon nanotubes are known and used for their excellent electrical and thermal conductivity properties as well as their mechanical properties. They are thus increasingly used as additives for providing materials, in particular those of the macromolecular type, with these electrical, thermal and/or mechanical properties (WO 91/03057; U.S. Pat. No. 5,744,235, U.S. Pat. No. 5,445,327, U.S. Ser. No. 54,663,230).

Applications of carbon nanotubes are found in numerous fields, in particular in electronics (depending on the temperature and their structure, they can be conductors, semi-conductors or insulators), in mechanics, for example for the reinforcement of composite materials (carbon nanotubes are a hundred times stronger and six times lighter than steel) and electromechanics (they can be elongated or contracted by charge injection).

There can, for example, be mentioned the use of carbon nanotubes in macromolecular compositions intended for packaging electronic components, for producing fuel lines, antistatic coatings, in thermistors, supercapacitor electrodes, etc.

Moreover, conductive organic compositions which specifically exhibit effects of positive or negative variation of electrical resistance as a function of temperature (PTC or NTC effect) and their use in resistive devices (U.S. Pat. No. 6,640,420) are well known.

These compositions are generally formulations based on macromolecular substances at least one component of which is semi-crystalline by nature such as for example polyethylene and which contain conductive additives, the best known being carbon black (J. of Pol. Sci. Part B-Vol. 41, 3094-3101 (2003)) or PVDF (US 20020094441 A1, U.S. Pat. No. 6,640,420).

The basic principle put forward is that the fusion of the crystalline domains increases the volume thus changing the macromolecular substance/conductive charge ratio causing the composition to change from a conducting regime to an insulating regime: the percolation threshold is thus cleared.

A PTC system can therefore be used as a system heating by Joule effect or an electric limiter (voltage or current: cut-out) by means of a resistance which increases rapidly as a function of temperature due to the Joule effect.

The PTC effect is utilized in order to produce thermistors, heating paints, vehicle-seat heating systems etc.

In the case of electroconductive organic compositions containing carbon nanotubes, aggregated or non-aggregated, there can for example be mentioned the patents WO 91/03057, U.S. Pat. No. 5,744,235, U.S. Pat. No. 5,611,964, U.S. Pat. No. 6,403,696.

More particularly, there can be noted Hyperion's patents U.S. Pat. No. 5,651,922, WO 94/23433 and EP692136 in which a parallel is drawn with carbon blacks or graphite in order to attribute a PTC effect to electrically conductive compositions containing nanotubes, i.e. the resistivity of which increases with the rise in temperature, for the purpose of ensuring the protection of electronic circuits and/or heating systems based on the Joule effect.

Moreover, the use of carbon nanotubes in organic compositions in order to obtain electrically conductive compositions having an effect opposite to the PTC effect, i.e. a resistivity independent of temperature is described in EP 1052654 with polyethylene- and polypropylene-type polymers. It is also noted that WO 03/024798 or US2003/122111 describe this use with polyimide-type polymers.

### SUMMARY OF THE INVENTION

The purpose of the invention is to propose the use of carbon nanotubes in other types of organic material with a view to producing conductive organic compositions having a temperature-insensitive electrical resistivity. By “insensitive”, is meant a relative variation less than or equal to 80%, preferably less than or equal to 50%, still more preferentially less than or equal to 30% over the working temperature range (in general from −50° C. up to the melting temperature of the polymer when the formulation is based on a semi-crystalline polymer or up to the vitreous transition temperature when the formulation is based on an amorphous polymer). In general, this temperature range is affected by the nature of the organic formulation used.

The organic materials used in the present invention are chosen from
a. The group of thermoplastic resins constituted by the resins:
   i. acrylonitrile-butadiene-styrene (ABS),
   ii. acrylonitrile-ethylene/propylene-styrene (AES),
   iii. methylmethacrylate-butadiene-styrene (MBS),
   iv. acrylonitrile-butadiene-methylmethacrylate-styrene (ABMS),
   v. acrylonitrile-n-butylacrylate-styrene (AAS),
b. modified polystyrene gums;
c. the following resins:
   i. polystyrene, polymethyl-methacrylate, cellulose acetate, polyamide, polyester, polyacrylonitrile, polycarbonate, polyphenyleneoxide, polyketone, polysulphone, polyphenylenesulphide;
d. the following resins:
   i. halogenated, preferably fluorinated such as polyvinylidene fluoride (PVDF) or also chlorinated such as polyvinyl chloride (PVC), siliconated, polybenzimidazole;
e. The group of thermosetting resins constituted by the resins based on phenol, urea, melamine, xylene, diallylphthalate, epoxy, aniline, furan, polyurethane;
f. The group of thermoplastic elastomers constituted by styrene-type elastomers such as styrene-butadiene-styrene block copolymers or styrene-isoprene-styrene block copolymers or their hydrogenated form, elastomers of PVC, urethane, polyester, polyamide type, polybutadiene-type thermoplastic elastomers such as 1,2-polybutadiene or trans-1,4-polybutadiene resins; chlorinated polyethylenes, fluorinated-type thermo-plastic elastomers, polyether esters and polyether amides;
g. The group of water-soluble polymers constituted by cellulosic polymers, polyelectrolytes, ionic polymers, acrylate polymers, acrylic acid polymers, gum arabic, poly (vinyl pyrrolidone), poly (vinyl-alcohol), poly (acrylic acid), poly (methacrylic acid), sodium polyacrylate, polyacrylamide, poly (ethylene oxide), polyethylene glycol, poly (ethylene formamide), polyhydroxyether, poly (vinyl oxazolidinone), methyl cellulose, ethyl cellulose, carboxymethyl cellulose, ethyl (hydroxyethyl) cellulose, sodium polyacrylate, their copolymers, and mixtures thereof;
h. The group constituted by polystyrene sulphonate (PSS), poly (1-vinyl pyrrolidone-co-vinyl acetate), poly(1-vinyl pyrrolidone-co-acrylic acid), poly (1-vinylpyrrolidone-co-dimethylaminoethyl methacrylate), polyvinyl sulphate, poly (sodium styrene sulphonic acid-co-maleic acid), dextran, dextran sulphate, gelatin, bovine serum albumin, poly (methyl methacrylate-co-ethyl acrylate), polyallyl amine, and their combinations.

A subject of the present invention is the use of carbon nanotubes for the production of a conductive organic composition having a temperature-insensitive electrical resistivity.

According to an embodiment of the invention, in the abovementioned use, the conductive organic composition also has a temperature-insensitive thermal conductivity.

According to another embodiment of the invention, in the abovementioned use, the composition comprises one or more electroconductive charges at least one charge of which comprises carbon nanotubes having an aspect ratio (L/D) greater than or equal to 5 and preferably greater than or equal to 50 and advantageously greater than or equal to 100.

According to yet another of the invention, in the abovementioned use, the percentage by weight of carbon nanotubes in the composition is less than 30%, preferably comprised between 0.01 and 20%, and advantageously between 0.1 and 15%.

According to yet another of the invention, in the abovementioned use, the carbon nanotubes have a diameter comprised between 0.4 and 50 nm and a length comprised between 100 and 100000 times their diameter.

According to an embodiment of the invention, in the abovementioned use, the carbon nanotubes are in multi-walled form, their diameter being comprised between 10 and 30 nm and their length being greater than 0.5 micron.

According to an embodiment of the invention, in the abovementioned use the organic composition has a percolation threshold ranging from 0.01 to 5%.

According to another embodiment of the invention, in the abovementioned use, the organic composition also comprises one or more macromolecular materials chosen from liquids such as oils, greases such as those used for lubrication, water- or solvent-based liquid formulations such as adhesives, paints and varnishes.

According to yet another embodiment of the invention, in the abovementioned use, the organic composition comprises at least one semi-crystalline type polymer.

The invention has a particularly striking application, within the framework of the abovementioned use, in the fields of the packaging of electronic components, the production of fuel lines, antistatic coatings, thermistors, supercapacitor electrodes, mechanical reinforcement fibres, textile fibres, rubber or elastomer formulations, seals, radiofrequency wave and electromagnetic wave screens.

A subject of the present invention is also, as a novel industrial product, a conductive organic composition having a temperature-insensitive electrical resistivity, comprising a quantity of up to 30% by weight, relative to the weight of the composition, of carbon nanotubes, the diameter of which is comprised between 0.4 and 50 nm, and the aspect ratio of which (L/D) is greater than 100. The present composition comprises at least one polymer material chosen from
a. The group of thermoplastic resins constituted by the resins:
   i. acrylonitrile-butadiene-styrene (ABS),
   ii. acrylonitrile-ethylene/propylene-styrene (AES),
   iii. methylmethacrylate-butadiene-styrene (MBS),
   iv. acrylonitrile-butadiene-methylmethacrylate-styrene (ABMS),
   v. acrylonitrile-n-butylacrylate-styrene (AAS),
b. modified polystyrene gums;
c. the following resins:
   i. polystyrene, polymethyl-methacrylate, cellulose acetate, polyamide, polyester, polyacrylonitrile, polycarbonate, polyphenyleneoxide, polyketone, polysulphone, polyphenylenesulphide;
d. the following resins:
   i. halogenated, preferably fluorinated such as polyvinylidene fluoride (PVDF) or also chlorinated such as polyvinyl chloride (PVC), siliconated, polybenzimidazole;
e. The group of thermosetting resins constituted by the resins based on phenol, urea, melamine, xylene, diallylphthalate, epoxy, aniline, furan, polyurethane;
f. The group of thermoplastic elastomers constituted by styrene-type elastomers such as styrene-butadiene-styrene block copolymers or styrene-isoprene-styrene block copolymers or their hydrogenated form, elastomers of PVC, urethane, polyester, polyamide type, polybutadiene-type thermoplastic elastomers such as 1,2-polybutadiene or trans-1,4-polybutadiene resins; chlorinated polyethylenes, fluorinated-type thermo-plastic elastomers, polyether esters and polyether amides;
g. The group of water-soluble polymers constituted by cellulosic polymers, polyelectrolytes, ionic polymers, acrylate polymers, acrylic acid polymers, gum arabic, poly (vinyl pyrrolidone), poly (vinyl-alcohol), poly (acrylic acid), poly (methacrylic acid), sodium polyacrylate, polyacrylamide, poly (ethylene oxide), polyethylene glycol, poly (ethylene formamide), polyhydroxyether, poly (vinyl oxazolidinone), methyl cellulose, ethyl cellulose, carboxymethyl cellulose, ethyl (hydroxyethyl) cellulose, sodium polyacrylate, their copolymers, and mixtures of the latter;
h. The group constituted by polystyrene sulphonate (PSS), poly (1-vinyl pyrrolidone-co-vinyl acetate), poly(1-vinyl pyrrolidone-co-acrylic acid), poly (1-vinylpyrrolidone-co-dimethylaminoethyl methacrylate), polyvinyl sulphate, poly (sodium styrene sulphonic acid-co-maleic acid), dextran, dextran sulphate, gelatin, bovine serum albumin, poly (methyl methacrylate-co-ethyl acrylate), polyallyl amine, and their combinations.

According to an embodiment of the invention, in said composition the carbon nanotubes have a diameter comprised between 10 and 30 nm and a length greater than 0.5 micron.

According to an embodiment of the invention, said composition also has a temperature-insensitive thermal conductivity.

According to another embodiment of the invention, in said composition, the percentage by weight of carbon nanotubes is comprised between 0.1 and 20%, and preferably between 1 and 15%.

According to another embodiment of the invention the composition has a percolation threshold ranging from 0.01 to 5% by weight of carbon nanotubes, preferably from 0.1 to 3%.

According to yet another embodiment of the invention, said composition also comprises one or more macromolecular materials chosen from liquids such as oils, greases such as those used for lubrication, water- or solvent-based liquid formulations such as adhesives, paints and varnishes.

According to yet another embodiment of the invention, said organic composition comprises at least one semi-crystalline type polymer.

### BRIEF DESCRIPTION OF THE FIGURES

FIG. 1 shows the percolation threshold of the organic composition used in the invention.

FIG. 2 shows the effect of resistivity which is constant as a function of temperature, with a concentration of nanotubes below the percolation threshold.

FIG. 3 shows the PTC effect of the reference example in comparison with the compositions used in the invention.

### DETAILED DISCLOSURE OF EMBODIMENTS OF THE INVENTION

The composition comprises one or more electroconductive (and or thermoconductive) charges at least one charge of which comprises carbon nanotubes having an aspect ratio (L/D) greater than or equal to 5 and preferably greater than or equal to 50 and advantageously greater than or equal to 100. The carbon nanotubes used in the invention generally have a tubular structure with a diameter of less than 100 nm, preferably comprised between 0.4 and 50 nm and/or generally a length greater than 5 times their diameter, preferentially greater than 50 times their diameter and advantageously comprised between 100 and 100000 or also comprised between 1000 and 10000 times their diameter.

The carbon nanotubes are constituted by an allotropic variety of carbon in an sp² configuration consisting of a long single-, double- or multi-walled tube of conjoined aromatic rings, aggregated or non-aggregated.

When the nanotube is constituted by a single tube, the term single-walled is used, if by two tubes the term double-walled is used. Beyond that, the term multi-walled is used. The external surface of the nanotubes can be uniform or textured.

By way of example, the single-walled, double-walled, or multi-walled nanotubes, nanofibres, etc. will be mentioned.

These nanotubes can be treated chemically or physically in order to purify them or functionalize them for the purpose of conferring novel dispersion properties upon them, and interaction with components of the formulation such as polymer matrices, elastomers, thermosetting resins, oils, greases, water- or solvent-based formulations such as paints, adhesives and varnishes.

The carbon nanotubes can be prepared according to different methods, such as the electric arc method (C. Journet et al. in Nature (London), 388 (1997) 756, the CVD gas phase method, Hipco (P. Nicolaev et al. in Chem. Phys. Lett, 1999, 313, 91), the laser method (A. G. Rinzler et al. in Appl. Phys. A, 1998, 67, 29), or any method producing tubular shapes which are empty or filled with carbonated substances or substances other than carbon. For example reference can be made more particularly to the documents WO 86/03455, WO 03/002456 for the preparation of separate or non-aggregated multi-walled carbon nanotubes.

The organic composition comprises one or more macromolecular materials.

These materials are generally liquids or solids such as oils or greases such as those used for lubrication, water- or solvent-based liquid formulations such as adhesives, paints and varnishes, polymers and copolymers, in particular thermoplastic or thermosetting, water-soluble polymers, elastomers and their formulations in mass, or in suspension or in dispersion etc.

As examples of thermoplastic resins the following resins can be mentioned:

acrylonitrile-butadiene-styrene (ABS), acrylonitrile-ethylene/propylene-styrene (AES), methylmethacrylate-butadiene-styrene (MBS), acrylonitrile-butadiene-methylmethacrylate-styrene (ABMS), acrylonitrile-n-butylacrylate-styrene (AAS),

gums of:

modified polystyrene,

the resins of:

polystyrene, polymethyl-methacrylate, polyvinyl chloride, cellulose acetate, polyamide, polyester, polyacrylonitrile, polycarbonate, polyphenyleneoxide, polyketone, polysulphone, polyphenylenesulphide, the following resins:

halogenated, preferably fluorinated such as PVDF or chlorinated such as PVC, siliconated, polybenzimidazole.

As examples of thermosetting resins, there can be mentioned resins based on phenol, urea, melamine, xylene, diallylphthalate, epoxy, aniline, furan, polyurethane, etc.

As examples of thermoplastic elastomers which can be used in the present invention there can be mentioned polyolefin-type elastomers, styrene-type such as styrene-butadiene-styrene block copolymers or styrene-isoprene-styrene block copolymers or their hydrogenated form, elastomers of PVC, urethane, polyester, polyamide type, polybutadiene-type thermoplastic elastomers such as 1,2-polybutadiene or trans-1,4-polybutadiene resins; chlorinated polyethylenes, fluorinated-type thermo-plastic elastomers, polyether esters and polyether amides etc.

As examples of water-soluble polymers there can be mentioned amphiphilic polymers, also called surfactant polymers, which contain both hydrophobic and hydrophilic segments, cellulosic polymers, polyelectrolytes, ionic polymers, acrylate polymers, acrylic acid polymers, the copolymers of the latter and their mixtures. Among the specific water-soluble polymers there can be mentioned gum arabic, poly (vinyl pyrrolidone), poly (vinyl-alcohol), poly (acrylic acid), poly (methacrylic acid), sodium polyacrylate, polyacrylamide, poly (ethylene oxide), polyethylene glycol, poly (ethylene formamide), polyhydroxyether, poly (vinyl oxazolidinone), methyl cellulose, ethyl cellulose, carboxymethyl cellulose, ethyl (hydroxyethyl) cellulose, sodium polyacrylate, their copolymers, and mixtures thereof.

There can also be mentioned polystyrene sulphonate (PSS), poly (1-vinyl pyrrolidone-co-vinyl acetate), poly(1-vinyl pyrrolidone-co-acrylic acid), poly (1-vinylpyrrolidone-co-dimethylaminoethyl methacrylate), polyvinyl sulphate, poly (sodium styrene sulphonic acid-co-maleic acid), dextran, dextran sulphate, gelatin, bovine serum albumin, poly (methyl methacrylate-co-ethyl acrylate), polyallyl amine, and their combinations.

The formulations of the organic compositions with constant resistivity are defined as a function of thermal energy with desired Joule effect and of the electrical power used (applied voltage or current).

Preferentially and essentially for reasons of cost of formulation, the percentage by weight of carbon nanotubes in the composition is less than 30%, preferably comprised between 0.01 and 20%, still more preferentially the percentage of nanotubes is comprised between 0.1 and 15%.

The composition with a resistivity which is constant as a function of temperature can be obtained by any process known to a person skilled in the art such as dry mixture, concentrated in a polymer or resin matrix, putting into suspension etc.

The mixing method can use different technologies such as those used for rubbers, polymers, liquids etc. There can be mentioned internal mixers, single- or double-screw extruders, nozzles, ultraturax-type mixers, ultrasound mixers or any type of mixing tool known to a person skilled in the art.

The compositions previously described can be obtained directly or by dilution via the use of a master batch as described in the patents WO 91/03057 or U.S. Pat. No. 5,646,990, EP 692136 or U.S. Pat. No. 5,591,382 U.S. Pat. No. 5,643,502 or U.S. Pat. No. 5,651,922, U.S. Pat. No. 6,221,283.

These compositions can also be obtained by direct synthesis of the organic material in the presence of carbon nanotubes, thus generating either a physical interaction between the polymer or copolymer and the carbon nanotubes or a covalent bond which is sought when aiming to significantly improve the mechanical properties (good transfer of the mechanical stresses between the matrix and the carbon nanotubes.

Moreover, the composition has a percolation threshold situated in the range from 0.01 to 5%, preferably from 0.1 to 3% by weight of carbon nanotubes.

The percolation threshold corresponds to the quantity of conductive charge in the macromolecular substance in order for the composition to transfer from a conducting regime to an insulating regime and vice versa.

Without being bound by any theory, the inventors have noted that the percolation threshold depends on the state of dispersion and therefore on the mixing tool and parameters. When dispersion is complete, i.e. all the nanotubes are dispersed individually, this threshold is proportional to the L/D aspect ratio. One of the ratios producing this threshold is (L/D).Fv˜3 where Fv is the volume fraction in carbon nanotubes. For example, for an L/D ratio ˜100, the volume fraction at the percolation threshold is 3% and 0.3% for L/D˜1000.

The compositions described above are used in all applications where a resistivity which is independent of temperature is sought.

Without being bound by any theory, the idea can be put forward that the percolation path of carbon blacks would be different from that of carbon nanotubes. In fact, the contacts in carbon black are point contacts and can be easily taken apart. For carbon nanotubes, even if these contacts are also point contacts, the sliding of the carbon nanotubes relative to each other would make it possible to maintain these contacts. The difference would therefore reside in the organisation of the conductive components. Carbon blacks are most often presented in the form of a string of beads (beyond the percolation threshold) whereas carbon nanotubes are most often presented in more or less entangled form. This level of entanglement would probably be responsible for the composition's constant resistance effect based on carbon nanotubes as a function of temperature.

Moreover, besides the constant resistivity effect, the compositions can have the same uses as known macromolecular compositions containing carbon nanotubes as mentioned in the following references: U.S. Pat. No. 6,689,835-U.S. Pat. No. 6,746,627-U.S. Pat. No. 6,491,789-Carbon, 2002.40 (10) 1741/1749-US2003/0130061-WO97/15934-JP 2004-244490-WO2004/097853-Science 2000, 290 (5495), 1331/1334-J. Mater. Chem., 2994.14, 1/3. In particular, the compositions according to the invention also exhibit the mechanical advantages linked to the use of nanotubes.

There can be mentioned the following applications: packaging of electronic components, production of fuel lines, antistatic coatings, thermistors, supercapacitor electrodes, mechanical reinforcement fibres, textile fibres, rubber or elastomer formulations such as tyres, seals and in particular gaskets, radiofrequency wave and electromagnetic wave screens, artificial muscle etc.

The compositions with resistivity which is constant as a function of temperature can be used in the final applications described above in different forms: liquid, hard or elastomeric solid, powder, film, fibre, gel etc.

### EXAMPLES

The following examples illustrate the present invention without however limiting its scope.

Carbon nanotubes obtained according to the method described in the patent PCT WO 03/002456 A2 are used. These nanotubes have a diameter comprised between 10 and 30 nm and a length>0.4 μm. They are presented, in the final composition, in multi-walled form in their totality or more than 98% in separate form i.e. non-aggregated. For the reference formulation a polymer formulation is used, with graphite and carbon black as additives, marketed by Timcal under the name ENSACO 250.

Halogenated, fluorinated or chlorinated polymer formulations such as PVDF or PVC are used.

In the following examples the polymer used is a PVDF-type thermoplastic polymer marketed by Arkema under the name Kynar 720.

Unless otherwise indicated, the quantities are expressed by weight.

In these examples, the plan for preparation of the compositions is the following:

The compositions are generally produced by mixing a polymer in the molten state with carbon nanotubes or the reference additive. The mixture is produced using an internal mixer for example of the Haak type.

The temperature of the mixture is generally approximately 230° C. The mixing time is affected by the stability of the mixer torque. In general, it is less than 7 minutes. The ingredients are introduced into the mixer as follows: first 50% of the polymer is introduced. When the polymer begins to melt, the conductive charge is added, then the remaining part of the polymer is added.

The electrical resistivity measurements are carried out using a dielectric system for poorly conductive compositions and by the four points method for those having resistivities of less than 10⁷ ohms·cm.

The PTC effect is evaluated using a dielectric spectrometer with a frequency of 50.02 Hz. In order to ensure the electrical contact, the sample in the form of compression-moulded plate is covered with a layer of silver on both its faces.

For each test, the sample is subjected to two heating processes of 3° C./min. The first ranges from −20° C. to 165° C. and the second from −20° C. to 180° C.

### Example 1

Various compositions according to the invention are prepared according to the method described above, with nanotube contents varying from 0 to 4%.

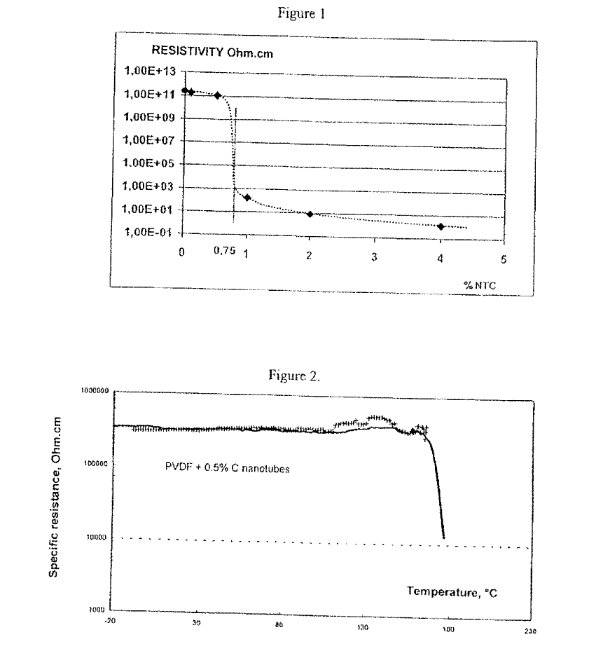

Beforehand, analysis of the resistivity of the PVDF/nanotube mixture was undertaken in order to find the percolation threshold. The results obtained are given in FIG. 1 and Table No. 1. The percolation threshold can be estimated at 0.75%.

TABLE 1

| Nanotube % | R(ohm · cm) |
|---|---|
| 0 | 2.00^{E11} |
| 0.1 | 1.3^{E11} |
| 0.5 | 5.4^{E10} |
| 1 | 168 |
| 2 | 9.2 |
| 4 | 1.2 |

In order to study the PTC effect, we have chosen compositions on either side of this threshold, namely 0.5, 1 and 2% nanotubes. These compositions are referenced IA, IB and IC.

### Example 2 (Comparative)

A composition is prepared according to the prior art according to the following composition:

70.4% of an organic composition based on PVDF 720

17.6% graphite

12% carbon black

### Test Results.

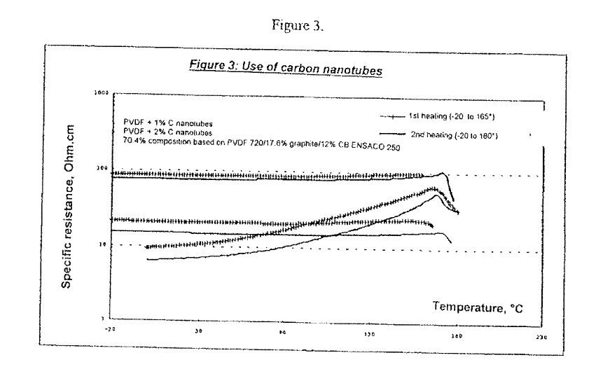

FIG. 2 shows the constant resistivity effect as a function of temperature, with a concentration of nanotubes below the percolation threshold.

The FIG. 3 shows the PTC effect of the reference example in comparison with the compositions used in the invention.

From the results shown in the curves in FIGS. 2 and 3, the PTC effect of the reference example, namely the increase in resistivity as a function of temperature, is clearly seen.

Thus the compositions of the invention have no PTC effect either before or after the percolation threshold.

We therefore obtain compositions the electrical resistivity of which is independent of temperature.

This constancy of electrical resistivity is maintained over the whole range of temperature variation up to the melting of the polymer matrix.

Moreover, this constant resistivity effect is combined with a very low percolation level.

1. Use of carbon nanotubes for the production of a conductive organic composition having a temperature-insensitive electrical resistivity, the organic composition comprising at least one polymer material chosen from:
a. The group of thermoplastic resins constituted by the resins:
i. acrylonitrile-butadiene-styrene (ABS),
ii. acrylonitrile-ethylene/propylene-styrene (AES),
iii. methylmethacrylate-butadiene-styrene (MBS),
iv. acrylonitrile-butadiene-methylmethacrylate-styrene (ABMS),
v. acrylonitrile-n-butylacrylate-styrene (AAS),
b. modified polystyrene gums;
c. the resins of:
i. polystyrene, polymethyl-methacrylate, cellulose acetate, polyamide, polyester, polyacrylonitrile, polycarbonate, polyphenyleneoxide, polyketone, polysulphone, polyphenylenesulphide;
d. the following resins:
i. halogenated, preferably fluorinated or chlorinated, siliconated, polybenzimidazole;
e. The group of thermosetting resins constituted by the resins based on phenol, urea, melamine, xylene, diallylphthalate, epoxy, aniline, furan, polyurethane;
f. The group of thermoplastic elastomers constituted by styrene-type elastomers such as styrene-butadiene-styrene block copolymers or styrene-isoprene-styrene block copolymers or their hydrogenated form, elastomers of PVC, urethane, polyester, polyamide type, polybutadiene-type thermoplastic elastomers such as 1,2-polybutadiene or trans-1,4-polybutadiene resins; chlorinated polyethylenes, fluorinated-type thermo-plastic elastomers, polyether esters and polyether amides;
g. The group of water-soluble polymers constituted by cellulosic polymers, polyelectrolytes, ionic polymers, acrylate polymers, acrylic acid polymers, gum arabic, poly (vinyl pyrrolidone), poly (vinyl-alcohol), poly (acrylic acid), poly (methacrylic acid), sodium polyacrylate, polyacrylamide, poly (ethylene oxide), polyethylene glycol, poly (ethylene formamide), polyhydroxyether, poly (vinyl oxazolidinone), methyl cellulose, ethyl cellulose, carboxymethyl cellulose, ethyl (hydroxyethyl) cellulose, sodium polyacrylate, their copolymers, and mixtures of the latter;
h. The group constituted by polystyrene sulphonate (PSS), poly (1-vinyl pyrrolidone-co-vinyl acetate), poly(1-vinyl pyrrolidone-co-acrylic acid), poly (1-vinylpyrrolidone-co-dimethylaminoethyl methacrylate), polyvinyl sulphate, poly (sodium styrene sulphonic acid-co-maleic acid), dextran, dextran sulphate, gelatin, bovine serum albumin, poly (methyl methacrylate-co-ethyl acrylate), polyallyl amine, and their combinations.

2. Use according to claim 1 in which the organic composition comprises a halogenated polymer.

3. Use according to claim 2 in which the halogenated polymer is a fluorinated resin.

4. Use according to claim 3 in which the fluorinated resin is polyvinylidene fluoride (PVDF).

5. Use according to claim 2 in which the halogenated polymer is a chlorinated resin.

6. Use according to claim 5 in which the chlorinated resin is polyvinyl chloride (PVC).

7. Use according to claim 1 in which the conductive organic composition also has a temperature-insensitive thermal conductivity.

8. Use according to claim 1 in which the composition comprises one or more electroconductive charges at least one charge of which comprises carbon nanotubes having an aspect ratio (L/D) greater than or equal to 5 and preferably greater than or equal to 50 and advantageously greater than or equal to 100.

9. Use according to claim 1 in which the percentage by weight of carbon nanotubes in the composition is less than 30%.

10. Use according to claim 1 in which the carbon nanotubes have a diameter comprised between 0.4 and 50 nm and a length comprised 100 and 100000 times their diameter.

11. Use according to claim 1 in which the carbon nanotubes are in multi-walled form, their diameter is comprised between 10 and 30 nm and their length is greater than 0.5 micron.

12. Use according to claim 1 in which the organic composition has a percolation threshold ranging from 0.01 to 5%.

13. Use according to claim 1 in which the organic composition further comprises one or more materials chosen from oils, greases, water, adhesives, paints or varnishes.

14. Use of an organic composition according to claim 1 in the fields of the packaging of electronic components, fuel lines, antistatic coatings, thermistors, supercapacitor electrodes, mechanical reinforcement fibres, textile fibres, rubber formulations, elastomer formulations, seals, radio frequency wave screens or electromagnetic wave screens.

15. Conductive organic composition having a temperature-insensitive electrical resistivity, comprising a quantity of up to 30% by weight, relative to the weight of the composition, of carbon nanotubes, the diameter of which is comprised between 0.4 and 50 nm, and the aspect ratio (L/D) of which is greater than 100 and comprising at least one polymer material chosen from
a. The group of thermoplastic resins constituted by the resins:
i. acrylonitrile-butadiene-styrene (ABS),
ii. acrylonitrile-ethylene/propylene-styrene (AES),
iii. methylmethacrylate-butadiene-styrene (MBS),
iv. acrylonitrile-butadiene-methylmethacrylate-styrene (ABMS),
v. acrylonitrile-n-butylacrylate-styrene (AAS),
b. modified polystyrene gums;
c. the resins of
i. polystyrene, polymethyl-methacrylate, cellulose acetate, polyamide, polyester, polyacrylonitrile, polycarbonate, polyphenyleneoxide, polyketone, polysulphone, polyphenylenesulphide;
d. the following resins:
i. halogenated, fluorinated or chlorinated, siliconated, polybenzimidazole;
e. The group of thermosetting resins constituted by the resins based on phenol, urea, melamine, xylene, diallylphthalate, epoxy, aniline, furan, polyurethane;
f. The group of thermoplastic elastomers constituted by styrene-type elastomers such as styrene-butadiene-styrene block copolymers or styrene-isoprene-styrene block copolymers or their hydrogenated form, elastomers of PVC, urethane, polyester, polyamide type, polybutadiene-type thermoplastic elastomers such as 1,2-polybutadiene or trans-1,4-polybutadiene resins; chlorinated polyethylenes, fluorinated-type thermo-plastic elastomers, polyether esters and polyether amides;
g. The group of water-soluble polymers constituted by cellulosic polymers, polyelectrolytes, ionic polymers, acrylate polymers, acrylic acid polymers, gum arabic, poly (vinyl pyrrolidone), poly (vinyl-alcohol), poly (acrylic acid), poly (methacrylic acid), sodium polyacrylate, polyacrylamide, poly (ethylene oxide), polyethylene glycol, poly (ethylene formamide), polyhydroxyether, poly (vinyl oxazolidinone), methyl cellulose, ethyl cellulose, carboxymethyl cellulose, ethyl (hydroxyethyl) cellulose, sodium polyacrylate, their copolymers, and mixtures of the latter;
h. The group constituted by polystyrene sulphonate (PSS), poly (1-vinyl pyrrolidone-co-vinyl acetate), poly(1-vinyl pyrrolidone-co-acrylic acid), poly (1-vinylpyrrolidone-co-dimethylaminoethyl methacrylate), polyvinyl sulphate, poly (sodium styrene sulphonic acid-co-maleic acid), dextran, dextran sulphate, gelatin, bovine serum albumin, poly (methyl methacrylate-co-ethyl acrylate), polyallyl amine, and their combinations.

16. Composition according to claim 15 comprising at least one halogenated polymer.

17. Composition according to claim 16 in which the halogenated polymer is a fluorinated or chlorinated resin.

18. Composition according to claim 17 in which the fluorinated resin is PVDF.

19. Composition according to claim 15 in which the carbon nanotubes have a diameter comprised between 10 and 30 nm and a length greater than 0.5 micron.

20. Composition according to claim 15, which also has a temperature-insensitive thermal conductivity.

21. Composition according to claim 15 in which the percentage by weight of carbon nanotubes in the composition is comprised between 0.1 and 20%.

22. Composition according to claim 15, having a percolation threshold ranging from 0.01 to 5% by weight of carbon nanotubes.

23. Composition according to claim 22 having a percolation threshold of 0.1 to 3% by weight of carbon nanotubes.

24. Composition according to claim 15 in which the organic composition further comprises one or more materials chosen from oils, greases, water adhesives, paints or varnishes.

25. Use of carbon nanotubes for the production of a conductive organic composition having a temperature-insensitive electrical resistivity, the organic composition comprising at least one halogenated, fluorinated or chlorinated polymer material.

26. Use according to claim 25 in which the halogenated polymer is a fluorinated resin.

27. Use according to claim 26 in which the fluorinated resin is polyvinylidene fluoride (PVDF).

28. Use according to claim 26 in which the halogenated polymer is a chlorinated resin.

29. Use according to claim 28 in which the chlorinated resin is polyvinyl chloride (PVC).

30. Use according to claim 25 in which the conductive organic composition also has a temperature-insensitive thermal conductivity.

31. Use according to claim 25 in which the composition comprises one or more electroconductive charges at least one charge of which comprises carbon nanotubes having an aspect ratio (L/D) greater than or equal to 5.

32. Use according to claim 25 in which the composition comprises one or more electroconductive charges at least one charge of which comprises carbon nanotubes having an aspect ratio (L/D) greater than or equal to 50.

33. Use according to claim 25 in which the composition comprises one or more electroconductive charges at least one charge of which comprises carbon nanotubes having an aspect ratio (L/D) greater than or equal to 100.

34. Use according to claim 25 in which the percentage by weight of carbon nanotubes in the composition is less than 30%.

35. Use according to claim 25 in which the percentage by weight of carbon nanotubes in the composition is between 0.01 and 20%.

36. Use according to claim 25 in which the percentage by weight of carbon nanotubes in the composition is between 0.1 and 15%.

37. Use according to claim 25 in which the carbon nanotubes have a diameter comprised between 0.4 and 50 nm and a length comprised 100 and 100000 times their diameter.

38. Use according to claim 25 in which the carbon nanotubes are in multi-walled form, their diameter is comprised between 10 and 30 nm and their length is greater than 0.5 micron.

39. Use according to claim 25 in which the organic composition has a percolation threshold ranging from 0.01 to 5%.

40. Use according to claim 25 in which the organic composition also comprises one or more macromolecular materials chosen from oils, greases, water, adhesives, paints or varnishes.

41. Use of the conductive organic composition according to claim 25 in packaging for electronic components, fuel lines, antistatic coatings, thermistors, supercapacitor electrodes, mechanical reinforcement fibres, textile fibres, rubber formulation, elastomer formulations, seals, radio frequency wave screens or electromagnetic wave screens.

42. Conductive organic composition having a temperature-insensitive electrical resistivity, comprising a quantity of up to 30% by weight, relative to the weight of the composition, of carbon nanotubes, the diameter of which is comprised between 0.4 and 50 nm, and the aspect ratio (L/D) of which is greater than 100 and comprising at least one halogenated, fluorinated or chlorinated polymer material

43. Composition according to claim 42 in which the halogenated polymer is a fluorinated resin.

44. Composition according to claim 42 in which the halogenated polymer is a chlorinated resin.

45. Composition according to claim 44 in which the fluorinated resin is PVDF.

46. Composition according to claim 44 in which the chlorinated resin is PVC.

47. Composition according to claim 42 in which the carbon nanotubes have a diameter comprised between 10 and 30 nm and a length greater than 0.5 micron.

48. Composition according to claim 42, which also has a temperature-insensitive thermal conductivity.

49. Composition according to claim 42 in which the percentage by weight of carbon nanotubes in the composition is comprised between 0.1 and 20%, and preferably between 1 and 15%.

50. Composition according to claim 42, having a percolation threshold ranging from 0.01 to 5% by weight of carbon nanotubes.

51. Composition according to claim 50 having a percolation threshold of 0.1 to 3% by weight of carbon nanotubes.

52. Composition according to claim 42 in which the organic composition also comprises one or more macromolecular materials chosen from liquids as oils, greases such as those used for lubrication, water- or solvent-based liquid formulations such as adhesives, paints and varnishes.

53. Use according to claim 1 in which the percentage by weight of carbon nanotubes in the composition is between 0.01 and 20.

54. Use according to claim 1 in which the percentage by weight of carbon nanotubes in the composition is between 0.1 and 15%.

55. Composition according to claim 15 in which the percentage by weight of carbon nanotubes in the composition is comprised between 1 and 15%.

56. Composition according to claim 17 in which the chlorinated resin is PVC.
